(19) United States
(12) Patent Application Publication
(10) Pub. No.: US 2002/0082977 A1
(43) Pub. Date: Jun. 27, 2002

(54) Aggregation of on-line auction listing and market data for use to increase likely revenues from auction listings

(76) Inventors: Mark S. Hammond, Zephyr Cove, NV (US); Vincent J. Bianco, San Clemente, CA (US); Mark R. Hilinski, Claremont, CA (US); Alex Dionysian, Rossmoor, CA (US); David Speights, Tustin, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/961,683

(22) Filed: Sep. 24, 2001

Related U.S. Application Data
(60) Provisional application No. 60/235,101, filed on Sep. 25, 2000.
(60) Provisional application No. 60/246,397, filed on Nov. 6, 2000.

(51) Int. Cl. G06F 17/60

(52) U.S. Cl. 705/37

(57) ABSTRACT

A web crawling engine is configured to mine auction web sites for auction market data. On-line auction market data are aggregated for use in determining how to best list an item for sale through an on-line auction. The market data include listing options (e.g., duration, opening bid) as well as data descriptive of the auction's progress (e.g., current bid). Auction market data can also be actively accumulated by actively listing items at auction, varying the listing options, and monitoring the same auctions. Data is analyzed to identify correlations between item listing options and desirable auction results, such as closing bid price. A multivariable curve fitting is performed based upon the accumulated data to create a function that yields auction revenue as a function of listing options. A set of options that corresponds to the maxima of this function is identified as an optimal set of listing options for a product.

### RELATED APPLICATIONS

This application claims the benefit of U.S. Provisional Application No. 60/235,101, filed on Sep. 25, 2000 and U.S. Provisional Application No. 60/246,397, filed on Nov. 6, 2000, which are hereby incorporated by reference.

### BACKGROUND OF THE INVENTION

1. Field of the Invention

This invention relates generally to web-based commerce and, more particularly, the invention relates to a system for increasing the revenue generated by the sale of items through web-based auctions.

2. Description of the Related Art

On-line web-based auction sites such as Ebay have provided a new and flexible market for a broad range of items. Items auctioned on-line generally include a variety of second-hand, refurbished, and even new items. The many available on-line auctions provide numerous options for listing items for sale. The time at which the auction takes place, the duration of the auction, the auction site, and the number of similar items listed for sale, among other factors, may all affect the closing bid price for an item.

### SUMMARY OF THE INVENTION

A system and associated methods provide auction-related data that enable auction sellers to list items so as to increase or maximize the likely revenue generated from the sale of the items through auctions.

In one embodiment, on-line auction market data is aggregated for use in determining how to best list an item for sale through an on-line auction. A web crawling engine is configured to mine auction web sites for auction market data for a product of interest. The market data preferably includes listing options or variables (e.g., duration, opening bid) as well as closing bid prices. The data is analyzed to identify correlations between item listing options and desirable auction results, such as closing bid price. In one embodiment, a multivariable curve fitting is performed based upon the accumulated data to create a function that yields auction revenue as a function of listing options. A set of options that corresponds to the maximum of this function is identified as an optimal set of listing options for a product.

In one embodiment, a system is preferably configured to collect data related to auction sales initiated by a seller in order to provide continuously updated information to the seller. The collected data may additionally include factors or characteristics of auctions, in addition to closing price, that may be of interest to the seller, such as the total number of bids on an item. Additional analyses of these characteristics are preferably performed, and results of these analyses are also made available to the seller. In one embodiment, one or more auctions are initiated at least in part in order to gather experimental data to thereby determine additional relationships between listing options and auction outcomes.

In one embodiment, an item is listed on multiple auctions. The bidding on the item on the multiple auctions is monitored, preferably continuously. As the auctions progress, the item is delisted (the auction listing for the item is cancelled) from auctions with inferior performance before the auctions close. The item can be delisted from all of the auctions in the case the top bid price appears as if it will be unacceptable to the seller. Alternatively, the item can be delisted from all but one of the auctions if the top bid price on the remaining auction appears as if it will be acceptable to the seller.

One embodiment of the invention is an auction listing analysis system that includes an auction data mining system configured to extract auction listing data and auction progress data from a plurality of auction listings. The system also includes an auction data processing system configured to receive the auction listing and progress data. The auction data processing system is further configured to process the auction listing and progress data to identify relationships between auction listing data and auction outcomes.

One embodiment of the invention is a method that includes identifying a set of auction listing variables. The method also includes identifying a plurality of auction listings. The method also includes, for each of the plurality of auction listings, identifying values for each of the auction listing variables. The method also includes, for each of the plurality of auction listings, identifying a closing price. The method also includes, based at least upon the identified values and the closing prices for the plurality of auction listings, determining a function that yields an output value as a function of the set of auction listing variables. The method also includes identifying a set of values for the auction listing variables that produces an extreme in the output value of the function.

One embodiment of the invention is a method that includes identifying an item to be listed on an auction. The method also includes identifying a plurality of auction listings for items similar to the item to be listed. The method also includes, for each of the identified auction listings, identifying auction options that were chosen by an auction seller. The method also includes monitoring the identified auction listings until auctions for the identified auction listings close. The method also includes identifying relationships between auction options and closing prices based at least upon the identified auction options and the monitoring of the identified auction listings.

One embodiment of the invention is a method that includes identifying an item to be sold at auction. The method also includes identifying a plurality of auction marketplaces in which items similar to the item have been sold. The method also includes selecting an auction marketplace based at least upon at least one of current sales of items similar to the item in the marketplace, bidding activity related to the item, percentage gain in recent bids related to the item, and a number of bidders in auctions related to the item. The method also includes collecting auction listing data and auction progress data for auctions of items similar to the item within the auction marketplace. The method also includes analyzing the auction progress data to determine supply and demand. The method also includes, based at least upon the determined supply and demand, determining a rate at which to list a plurality of the item in successive auctions within the marketplace.

One embodiment of the invention is a method that includes listing a single item for sale in a plurality of auctions simultaneously. The method also includes collecting auction progress data during the plurality of auctions. The method also includes ranking the plurality of auctions based at least upon at least one of a current bid price, a number of bidders, and a percentage increase in a most recent bid. The method also includes delisting the item from all but one of the auctions based at least upon the ranking.

### BRIEF DESCRIPTION OF THE DRAWINGS

FIG. 1 illustrates a system for aggregating and analyzing auction listing and market data.

FIG. 2 illustrates a method for modeling profits in auctions.

FIG. 3 illustrates a method that can be performed in accordance with one embodiment.

FIG. 4 illustrates a method of selecting auction variables for listing a product so as to increase the likely auction outcome.

FIG. 5 illustrates a method for listing a single product for sale through multiple auctions.

### DETAILED DESCRIPTION OF THE INVENTION

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent components and methods to those described herein. In other instances, well-known components and methods have not been described in detail so as not to unnecessarily obscure aspects of the present invention.

I. System Overview

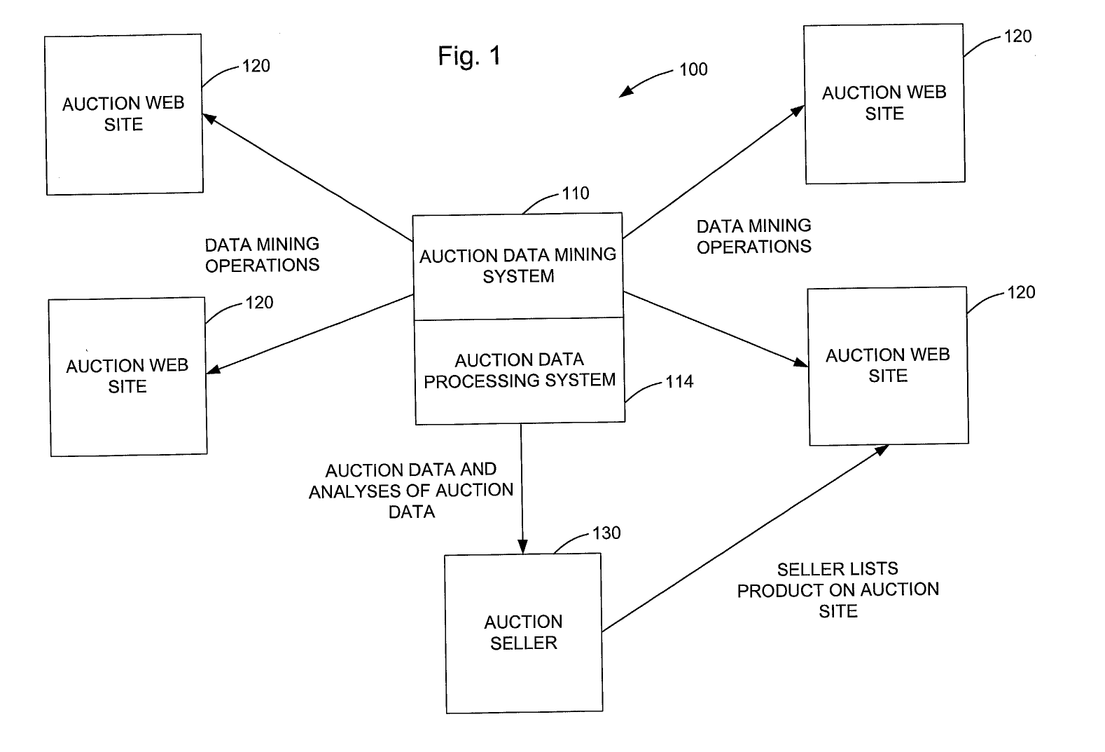

FIG. 1 illustrates a system 100 for aggregating and analyzing auction listing and market data. The system 100 preferably includes an auction data mining system 110 and an auction data processing system 114. The system 100 can also include an auction seller 130 and one or more auction sites 120. The auction data mining system 110 is configured to query the auction web sites 120 for auction data on products of interest. The auction data mining system 110 provides the aggregated data to an auction data processing system 114, which processes the data. The auction data processing system 114 provides the aggregated data and/or analyses of the data to an auction seller 130. The auction seller 130, in turn, preferably makes use of the received data in listing products for sale on one of the auction sites 120.

The seller 130 and auction sites 120 can be part of the system 100 or can be separate from the system 100. In one embodiment, the system 100 is operated by an entity that also operates one or more sellers 130 and/or one or more auction sites 120. Alternatively, different entities can operate the system 100, the seller 130 and the auction sites 120. Although only one seller 130 is illustrated, there may be multiple sellers 130, each of which can be an individual entity or person.

II. Auction Model

In one embodiment, the system 100 is configured to determine the best characteristics for listing specific items to obtain the maximum auction outcome. The auction outcome can represent a result of interest, such as net return or closing bid. In accordance with one embodiment, the auction outcome is specified as net return as follows:

Net_{—}return=Closing_{—}Bid−ΣCosts

The closing bid represents the final winning bid in an auction. The costs preferably include any costs that are subtracted from the closing bid to yield the net return. Costs can include, for example, the cost of listing the item at auction, the cost of featuring an auction listing, or the cost associated with a shipping charge charged to the purchaser. A cost can be either positive or negative. A large shipping charge to the purchaser, for example, can have a negative cost in that it may cost less than the shipping charge to ship a product. For a given item, the system 100 can be configured to determine the auction variables that are likely to produce the largest net return.

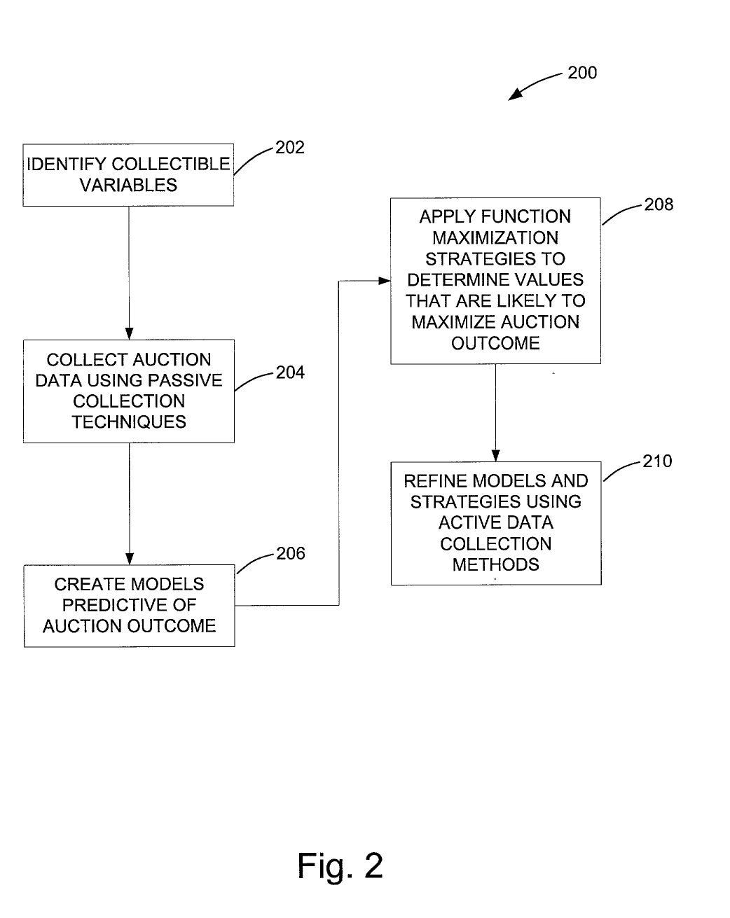

FIG. 2 illustrates a method 200 for modeling auction outcomes in accordance with one embodiment. The steps of the method 200 will be described throughout the remainder of this section.

A. Auction Listing Variables

At a first step 202 of the method 200, collectible variables that can be obtained from on-line auctions are identified. These variables can include auction parameters, product variables, and other variables (e.g., time of day, auctioneer, auction site, etc.).

In one embodiment, the collectible variables can include some or all of the following auction listing variables:

the auction site

item identifier (e.g., UPC code, manufacturer/part number)

merchandise/listing title

category and subcategory in which the product is listed

opening bid price

first bid

highest bid

the bid increment

the reserve (minimum) bid price, if specified

auction/listing start time

auction/listing start day of week

auction end time

auction end day of week

shipping charges

text description of the item

warrantee period, if any

whether the item is new or used

whether returns are permitted by the seller

whether a picture of the product is provided

promotional attributes (e.g., whether the item is “featured,” listed in bold).

Certain auction listing variables can be associated with costs that are included in the determination of the net return, as discussed above. In one embodiment, for certain fields, an associated cost field reflecting a cost to the seller can be maintained.

Other variable types that may also be of interest can require considerable manipulation prior to usage in a statistical model. For example, one of the data fields collected from an on-line auction can be a free text description of the product. Alone, this text is difficult to use within a model. Using text processing techniques, however, multiple variables can be derived from text strings that represent meanings that are predictive of auction outcome.

As will be understood by one skilled in the art, many variations on the techniques listed in this section can be utilized to create a rich source of variables from which to construct statistical models.

B. Passive Data Collection

At a step 204, the auction data mining system 110 collects data for the collectible variables identified in the step 202. The data are preferably collected using passive collection techniques by monitoring multiple auctions.

Passive data collection is an observational data collection method that preferably entails collecting data on auctions where the auction parameters are not manipulated by the collector, but are determined by other sellers. This method of data collection has the primary advantage of enabling the collection of enormous amounts of data with relatively small amounts of effort. In addition, data can be continuously collected at all times to keep as up to date as possible with auctioning techniques. One disadvantage of this method can be a lack of experimental design. Since many on-line auctions will be performed in a similar manner, representative mixtures of the collectible variables may not be obtained.

C. Model Generation

At a step 206 of the method 200, the relationships between auction outcome and collected predictor variables are analyzed to create one or more models predictive of auction outcome.

There are many types of models that can be utilized to predict auction outcome using multiple variables. In accordance with one embodiment, the system 100 preferably uses a series of statistical models to optimally determine parameters for on-line auctions. A basic statistical model for describing the relationship of auction outcome, P, to auction parameters, A, and other variables, O, is of the form

P=f_{Θ}(A,O,E)

where f_{Θ}( . . . ) represents some model applied to A and O to forecast P with a parameter set Θ={Θ₁, Θ₂, . . . , Θₙ}, and where error in the statistical model is represented as E. The parameters for an auction can be used as model covariates to forecast P. A set of K parameters can be represented by the set A={A₁, A₂, . . . , A_{K}}. Additional variables can be used to represent the other information involved in the auction. Other information may be the type of product, a description of the product, the auction site, time of day, estimated demand, or other factors that can be used to reduce the model error. A set of J other information variables can be represented by the set O={O₁, O₂, . . . , O_{J}}. The model defines the relationship of P to O and A.

This general model design encompasses most statistical models that can be formulated to model the relationship between P, A and O. The flexibility of this model also extends to include composite models consisting of many submodels.

A model can be used in a hierarchical structure where the variables in the model are themselves outputs of another model. For example, it may be useful to use market segment as a predictor variable in the model. Market segment can be determined from a cluster analysis model fit to the data to segment products into particular market segments. A variable can be obtained from a clustering model and used as a predictor variable in a model to forecast auction outcomes.

D. Model Analysis

At a step 208, auction outcome maximization strategies are applied to the models constructed in the step 206.

Once a model is obtained and the parameters are estimated, the optimal settings for A can be determined through function maximization. In some cases, the model in question will not have a maximum or the maximum will be unrealistic. In these cases, certain changes to the model design may be required. For example, a penalty function can be applied to areas of the parameter space to cause the function to have a maximum with respect to A. In some instances, other modeling approaches will need to be applied.

The following is a list of some techniques that can be used to determine these relationships.

Multiple Linear Regression

Feed Forward Neural Networks

Log-normal regression

Box-Cox transformation models

Non-Parametric Regression models

Additive regression models

Projection pursuit regression models

This list is in no way exhaustive, however, it includes many of the standard techniques used in modeling continuous outcome data. The primary motivations for a particular model choice are reducing the model error, fitting the distribution of the data correctly, and increasing prediction accuracy.

In order to reduce the model error as much as possible, the data elements in A and O are preferably chosen to contain rich and meaningful information. Much of this information can be derived from multiple data sources that exist with on-line auctions. Many of the data elements of interest can contain information about an industry trend or a specific type of product. This type of information is preferably compiled using, for example, all auctions conducted in a period of time on a single piece of merchandise.

E. Active Data Collection

At a step 210, the models and strategies are refined using active data collection methods in order to resolve unanswered model problems.

Active data collection preferably involves the use of experiments where the auction parameters are manipulated to systematically determine relationships. This method of data collection can employ a carefully designed experiment that manipulates the parameters of A for various levels of O to measure relationships with P. This method is likely to give the most reliable and unbiased estimates for high-volume auction products, since experiments can be performed on actual merchandise being auctioned.

Active and passive data collection methods are preferably employed in the model design and estimation. It is likely, however, that the amount of data from active data collection will be far less than the amount of data from passive data collection. Therefore, passive data collection methods are preferably used to discover the basic relationships of P to A and O. Active data collection methods can then be used to fine-tune the models.

In one embodiment, the steps 208 and 210 can be repeated again and again to further refine the optimal settings that are likely to maximize auction outcome.

F. Auction Supply and Demand

In one embodiment, the system 100 is configured to monitor the progress of auctions to determine supply and demand for auction products. One of the largest elements in determining price is demand. If the demand for a product is high, a higher selling price can be achieved and an increased volume of bids will be received. Demand can be determined by aggregating data from multiple auctions. Demand may be represented as a series of indices that are developed from multiple auction sources.

The system 100 preferably measures listing and bidding activity on one or more auction sites for items of interest. The activity data can be aggregated for each of several auction sites and products. The activity data can be maintained separately for different items and auctions or the data can be combined. The activity data can include, for example:

the item or product

the number of the item listed

the number of bids

the current bid price

the last closing price

whether the reserve price has been met

the actual or apparent final bid price

Supply and demand functions and curves can be created based upon the collected activity data. By collecting activity data over time, supply and demand functions and curves can be determined as functions of time (e.g., time of day, day of week, or both).

The system 100 preferably measures the times (day of the week, hour, etc.) at which products sell for the best price. The supply and demand curves generated by the system can be used to determine the best time to list a product at auction.

In one embodiment, the system 100 measures demand and supply as a function of time of day, day of week, and auction site, to determine the optimal time and auction site upon which to list products.

In one embodiment, the system 100 graphs the relationship between the number of products to be sold against likely closing price. This aspect enables, for example, a forecast on selling 200 DVD players where 35 can be sold at $250.00, 25 at $225.00, 55 at $200.00, and the remaining below $175.00.

The system 100 can be configured to detect the listing of a similar product on an auction and possibly avoid that auction altogether. The system can be configured to determine that an auction is saturated with a specific product. In this case, the system can be configured to identify alternative times at which products should be listed. Instead of bulk listing multiple items, the system 100 can be configured to provide multiple times at which multiple similar or identical items can be listed to trickle the items out to the market to compensate for low demand over time.

III. Methods

A. Analysis Method

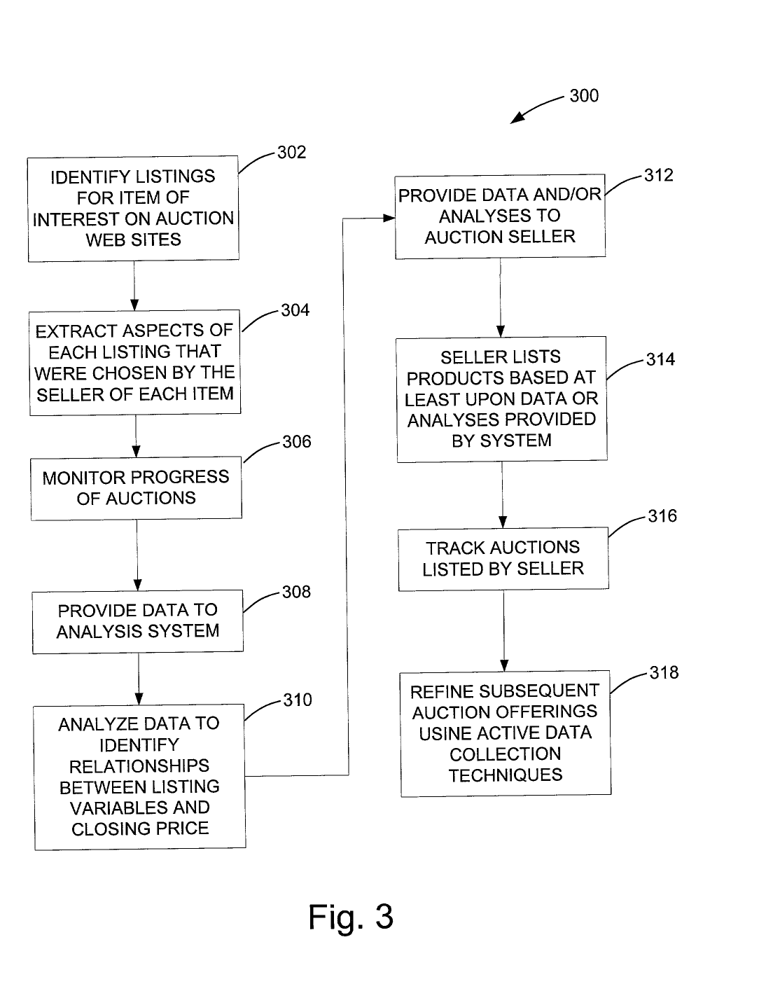

FIG. 3 illustrates a method 300 that can be performed in accordance with one embodiment.

At a step 302, the auction data mining system 110 uses known techniques to identify listings for an item or product of interest on the auction web sites 120. Such techniques may involve crawling auction web sites for matches to a product name, product number, or other information that may uniquely identify a product. Alternatively, many auction web sites provide search utilities for searching auction entries. These search utilities can also be used by the system 110. As another alternative, general descriptions of a product can be used to search for listings that may generally apply to the product of interest. The auction data mining system 110 preferably identifies most or all auctions for a particular product of interest on a set of auction sites of interest. Accordingly, the auction data mining system effectively gathers supply information on how many units of a product are being offered, for a product of interest within a particular auction market context. The system 110 can also be configured to continually crawl the web for new auction sites.

At a step 304, once the mining system 110 has identified a listing for a product of interest, the system 110 extracts from the listing various aspects of the listing that were chosen or selected by the seller of the item. These aspects can include, for example, the auction site, the opening bid price, or other characteristics of the listing. The extraction of these aspects from listings can be performed using parsing, pattern matching, or other known techniques. The system 110 preferably performs the step 304 for each of multiple auction listings for a product.

At a step 306, for an identified listing of a product of interest, the mining system 110 preferably also periodically checks the progress of the auction. At periodic intervals, the mining system 110 preferably logs, for example, the time of the check, the number of bids, the current bid price, whether the reserve price has been met, and the actual or apparent final bid price, if applicable. The mining system 110 preferably continues gathering this data until the auction has ended. The system 110 preferably performs the step 306 for each of the several auction listings for the product.

The steps 304 and 306 are preferably repeated continuously for multiple products. As the auction data mining system 110 performs the steps 304 and 306, it accumulates data regarding the static (chosen by the seller) and dynamic (that change as the auction progresses) aspects of each identified auction.

At a step 308, as the auction data mining system 110 gathers data in the steps 304 and 306, it preferably provides the data (hereinafter “raw data”) to the auction data processing system 114.

At a step 310, the auction data processing system 114 analyzes the data. The auction data processing system 114 can be configured to perform any number of analyses of the raw data. Some possible analyses are described in the following paragraphs.

One possible analysis that can be performed by the auction data processing system 114 is the calculation of a demand curve for a product of interest. The actual or approximate closing auction price of a tracked auction is preferably included in the raw data extracted in the step 306. At the time an auction closes, the total number of a particular product of interest listed for sale on all auctions within a particular context is calculated from the raw data. The context can be a single auction site, multiple selected auction sites, or all auction sites. Accordingly, a price can be associated with a number of a product offered for sale within the context. One data point can be generated from each closing auction so that multiple auction closings will yield several data points. A curve fitting can be performed on these data points in accordance with known techniques to create a demand curve for the context of interest.

Another possible analysis can be used to determine preferable ways to list auction products. For any product, a likely closing bid price function can be formulated to take into account controllable variables such as the auction site chosen, the time and duration of the auction, the opening price, the use and level of reserve pricing, the use of bold or featured listings, etc. A likely auction revenue function can be created by subtracting calculated auction costs based upon known auction policies. The maxima of the known auction revenue function can be calculated using known techniques to find the combination of listing characteristics that are likely to yield the highest final bid.

At a step 312, the raw data, the analyses performed by the auction data processing system 114, or both are provided to the auction seller 130. In one embodiment, the raw data or analyses can be made available to a seller through a website. Alternatively, the data or analyses can be provided through a direct connection between the auction data mining and processing systems 110 and 114 and a system operated by the seller. As another alternative, auction data mining and processing systems 110 and 114 can be integrated with the seller's system.

At a step 314, the seller 130 lists products on auctions based upon the raw data provided by the auction data mining system 110 or the analyses performed by the auction data processing system 114. The raw data or analyses preferably enable the seller 130 to maximize the selling price of products listed at auction.

At a step 316, the auction data mining and processing systems 110 and 114 also track the auctions listed by the seller 130. Alternatively or additionally, the seller 130 can monitor the closing price of its own auctions.

At a step 318, the seller preferably uses active data collection techniques to further refine the variables of subsequent auction offerings. The active data collection techniques can involve adjusting the variables or options the seller's own auctions or performing analyses of data collected with respect to these auctions. Applicable active data collection techniques are described in additional detail above.

B. Method for Listing Products

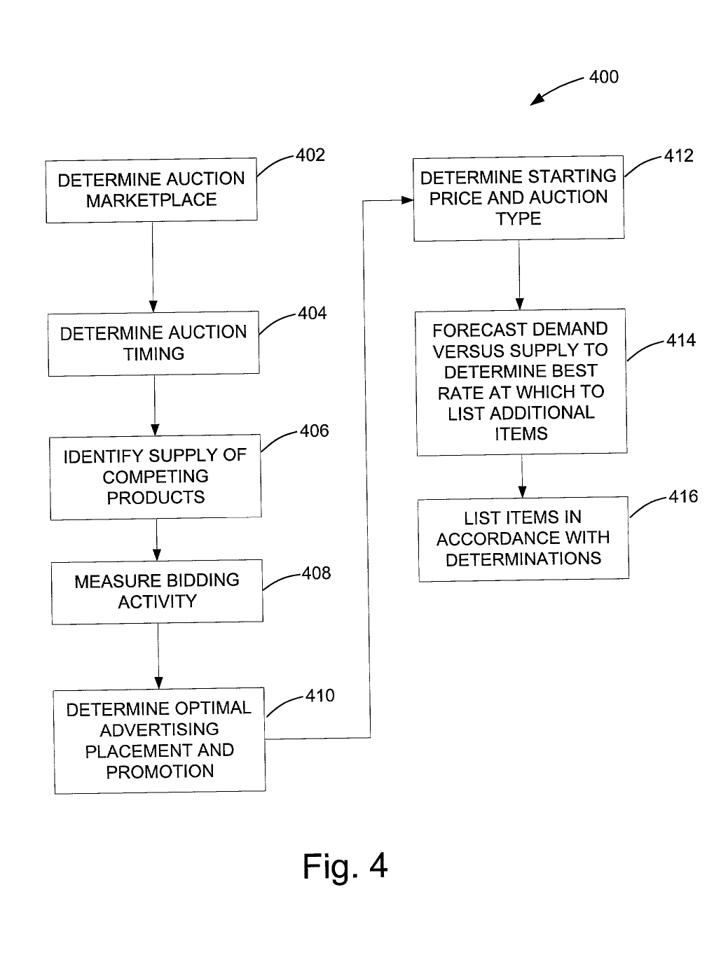

FIG. 4 illustrates a method 400, in accordance with one embodiment, of selecting auction variables for listing a product so as to increase the likely auction closing price (the auction outcome).

At a step 402, the auction marketplace is determined. The marketplace can include the auction site or sites, the category, and the subcategory of the auction. In this step, auction sites can be crawled for prior and current sales of a particular product or a similar product. In one embodiment, prior sales are regarded as favorable and current sales are regarded as unfavorable.

At a step 404, the timing of the auction is determined. The timing can include when to start the auction, the duration of the auction, and the time of day and day of the week to end the auction. In this step, times that products sell at the best price are preferably measured and traffic of auctions is preferably measured by time of day and day of week.

At a step 406, the supply of similar or competing products is identified. In this step, the number of product listings for each auction category or subcategory can be measured. An auction with the smallest supply is preferably selected.

At a step 408, bidding activity is measured. In this step, auctions can be ranked from highest number of bids to lowest on a same or similar product. Auctions can be ranked from highest percentage gain between the last two bids to lowest percentage gain. Auctions can also be ranked from highest to lowest number of bidders.

At a step 410, the optimal advertising placement and promotion for a product is determined to identify maximum exposure to target bidders and buyers. In this step, the effect upon the number of bids/hits of brand name listings, category versus subcategory listings, bold listings, up-front listings, top-of-page listings, and featured listings can be determined.

At a step 412, the optimal starting price and auction type is determined. In the step 412, the effect of different starting prices can be measured. The effect of using a reserve also can be measured. In addition, the effectiveness of different types of auctions for the same or similar products can be measured. The different types of auctions can include, for example, reverse auction, dutch auction, name your own price auction, and regular auction.

At a step 414, demand is forecast against supply to determine a best rate or supply flow at which multiple auctions should be started for the same product. In the step 414, the methods discussed in the above subsections are preferably applied.

At a step 416, items are listed on auctions based at least upon the determinations of one or more of the previous steps.

C. Iteratively Refining Auction Variables

In one embodiment, if a seller's auction closes with a successful bid, auction settings can be slightly modified for the next auction of the same item based on heuristic rules. If the auction outcome improves compared to a previous setting, the new setting can be used as the optimal setting for an item, and a next auction setting can be modified in the same direction as the previous modification and the process repeated. Otherwise, if the auction outcome is less than the original auction outcome or if the auction does not get a successful bid, the attribute that was modified can be reset to its original setting. Next, an alternative attribute can be modified and the process 200 can be repeated. In one embodiment, active data collection can be performed by making successive adjustments to auction listings in this manner.

IV. Demand Bid Locator

In accordance with one embodiment, the system 100 functions as a demand bid locator that identifies buyers of a product. An item is listed on multiple auctions. The bidding on the item on the multiple auctions is monitored, preferably continuously. As the auctions progress, the item is delisted (the auction listing for the item is cancelled) from auctions with inferior performance before the auctions close. The item can be delisted from all of the auctions in the case where the top bid price appears as if it will be unacceptable to the seller. Alternatively, the item can be delisted from all but one of the auctions if the top bid price on the remaining auction appears as if it will be acceptable to the seller.

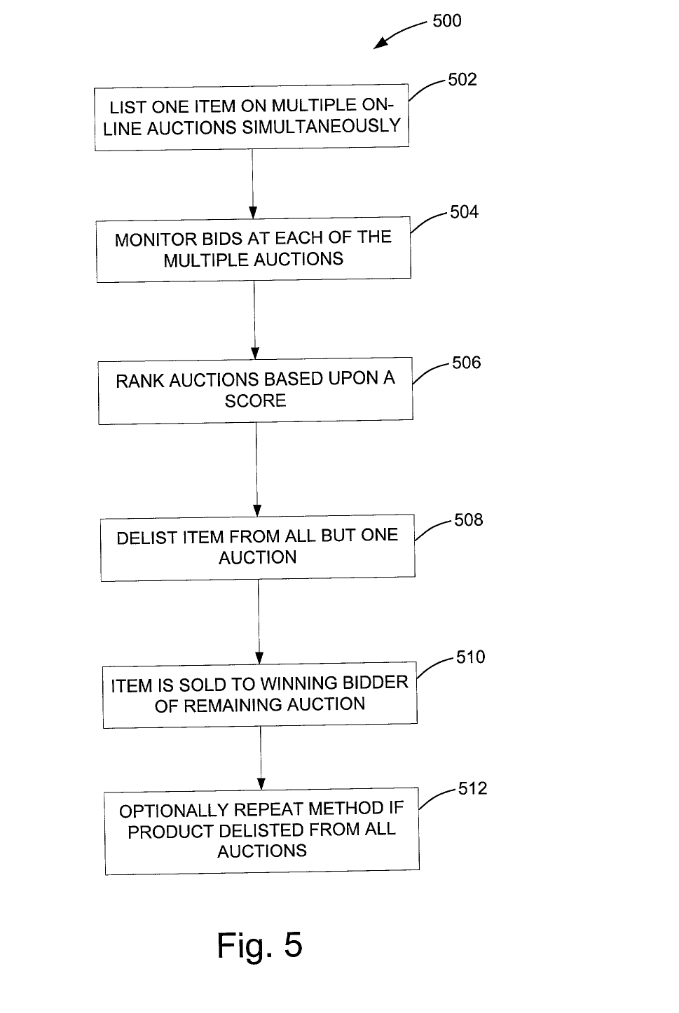

FIG. 5 illustrates a method 500 for listing a single item for sale through multiple auctions. In one embodiment, the method 500 is performed automatically by the system 100, which can include the seller 130.

At a step 502, the item is listed, preferably simultaneously, on multiple web-based or on-line auction sites. One or more of the auctions may be operated by the system 100. In one embodiment, the item is listed in a first auction. The item is then listed in a second auction before the first auction closes and preferably at the same time as the listing on the first auction. All of the auctions are preferably set to close at the same time.

At a step 504, the bid price and/or the bid activity is monitored at each of the auction sites. On-line auction sites typically provide the current bid price for an item throughout an auction. Some on-line auction sites may also list data on the number of bids that have been placed for an item. This information can be automatically gathered by the auction data mining system 110.

At a step 506, the auctions are ranked by a demand score. Each auction can be scored based upon one or more factors such as, for example:

current bid price

number of bids

frequency of bids

percentage increase of bids

number of bidders

whether most recent bid is from a new bidder

time left in the auction

In one embodiment, all auctions are ranked first by bid price, ranked second by number of bidders, and ranked third by percentage increase of last bid over the previous bid. If two auctions have the same bid price, the rank can then be based upon the number of bidders. If the number of bidders is the same, rank can then be based upon the percentage increase of last bid over the previous bid. For example, if auction A has one bidder at $100 and auction B has two bidders at $100 then auction B can be maintained while auction A is dropped.

At a step 508, the item is delisted from all but one of the auctions. Delisting an item involves removing an item from an auction and canceling the auction before its close. In one embodiment, auctions that have lower scores are delisted earlier. Auctions with higher scores can be maintained until near the close of the auctions. In one embodiment, near the close of the auctions, the item is delisted from all but the auction with the highest bid. The step 508 is preferably performed in the last hour of the auctions. The step 508 can be performed in the final minutes of the auctions.

At a step 510, the remaining auction is allowed to close, and the item is sold to the winning auction bidder of that auction. Optionally, if a satisfactory bid price has not been reached in any auction, the item can be delisted from all auctions.

At a step 512, the system 100 can be configured to automatically repeat the method 500 if no auction was allowed to close successfully.

In one embodiment of the method 500, the item is delisted from all but the auction having the highest bidding price. Alternatively, the item may be delisted from all but the auction with the most activity or bids placed. The item may be delisted from one auction at a time, or the item may be delisted from multiple auctions at once. For example, an item may be simultaneously listed on four auctions, each closing four days later. At the end of the third day, the item may be delisted from the three auctions with the lowest bid prices. The auction with the highest bid after three days is allowed to close on the fourth day and the auction item is sold to the winning bidder of that auction.

In one embodiment, the method 500 is applied to the sale of multiple identical items. In this case, the item is delisted from all but N auctions, where N is the number of items offered.

In one embodiment, a reserve or minimum bid is used as an alternative to delisting. A high reserve or minimum bid can be set in all auctions. The reserve or minimum bid can be lowered for an auction in order to allow a preferred auction to close successfully. The high reserve or minimum bid can be maintained on the remaining auctions to cause those auctions to close without a winning bidder.

V. Additional Applications

In one embodiment, the invention is used in conjunction with a product return system. The product return system receives product returns from customers of one or more retailers and recaptures residual value of the returned products by auctioning the returned products on-line. An applicable product return system is described in International Patent Application PCT/US01/06469, filed Feb. 28, 2001, published Sep. 13, 2001 as WO 01/67344, and titled “PRODUCT RETURN SYSTEM AND METHODS,” which application has been assigned to the assignee of the present application and which application is hereby incorporated herein by reference.

VI. Conclusion

Although the invention has been described in terms of certain embodiments, other embodiments that will be apparent to those of ordinary skill in the art, including embodiments which do not provide all of the features and advantages set forth herein, are also within the scope of this invention. Accordingly, the scope of the invention is defined by the claims that follow. In the method claims, reference characters are used for convenience of description only, and do not indicate a particular order for performing a method.

What is claimed is:

1. An auction listing analysis system comprising:
an auction data mining system configured to extract auction listing data and auction progress data from a plurality of auction listings; and
an auction data processing system configured to receive the auction listing and progress data, the auction data processing system further configured to process the auction listing and progress data to identify relationships between auction listing data and auction outcomes.

2. The system of claim 1, further comprising an auction seller that lists items on auctions based at least upon the relationships identified by the auction data processing system.

3. The system of claim 2, further comprising an auction web site, wherein the auction web site hosts the auctions upon which the seller lists the items.

4. The system of claim 1, wherein the auction listing data represent choices made by sellers in listing items in auctions.

5. The system of claim 1, wherein the auction listing data comprise an opening bid.

6. The system of claim 1, wherein the auction listing data comprise an identification of a listed item.

7. The system of claim 1, wherein the auction progress data comprise a closing bid.

8. A method comprising:
identifying a set of auction listing variables;
identifying a plurality of auction listings;
for each of the plurality of auction listings, identifying values for each of the auction listing variables;
for each of the plurality of auction listings, identifying a closing price;
based at least upon the identified values and the closing prices for the plurality of auction listings, determining a function that yields an output value as a function of the set of auction listing variables; and
identifying a set of values for the auction listing variables that produces an extreme in the output value of the function.

9. The method of claim 8, wherein the output value is related to an expected net return from an auction listing.

10. The method of claim 8, wherein the extreme in the output value of the function identifies a maximum likely net return from an auction listing.

11. The method of claim 8, further comprising listing an item at auction based at least upon the identified set of values for the auction listing variables.

12. The method of claim 8, further comprising listing the plurality of auction listings, wherein, for each of the plurality of auction listings, the auction listing variables have a different set of values than any other of the auction listings.

13. The method of claim 8, wherein the plurality of auction listings are listed on a plurality of different on-line auction sites.

14. A method comprising:
identifying an item to be listed on an auction;
identifying a plurality of auction listings for items similar to the item to be listed;
for each of the identified auction listings, identifying auction options that were chosen by an auction seller;
monitoring the identified auction listings until auctions for the identified auction listings close; and
identifying relationships between auction options and closing prices based at least upon the identified auction options and the monitoring of the identified auction listings.

15. The method of claim 14, further comprising listing a plurality of new auction listings based at least upon the identified relationships.

16. The method of claim 15, further comprising monitoring the plurality of new auction listings.

17. The method of claim 16, further comprising refining the identified relationships based at least upon the monitoring of the plurality of new auction listings.

18. A method comprising:
identifying an item to be sold at auction;
identifying a plurality of auction marketplaces in which items similar to the item have been sold;
selecting an auction marketplace based at least upon at least one of current sales of items similar to the item in the marketplace, bidding activity related to the item, percentage gain in recent bids related to the item, and a number of bidders in auctions related to the item;
collecting auction listing data and auction progress data for auctions of items similar to the item within the auction marketplace;
analyzing the auction progress data to determine supply and demand; and
based at least upon the determined supply and demand, determining a rate at which to list a plurality of the item in successive auctions within the marketplace.

19. The method of claim 18, wherein the auction marketplace is selected based at least upon the number of bidders in auctions related to the item.

20. The method of claim 18, further comprising analyzing the collected auction listing data or the auction progress data to identify a preferable timing for starting or ending an auction.

21. The method of claim 18, further comprising analyzing the collected auction listing data or the auction progress data to identify a featuring strategy for listing the item.

22. The method of claim 18, further comprising analyzing the collected auction listing data or the auction progress data to identify a starting price for listing the item.

23. A method comprising:
listing a single item for sale in a plurality of auctions simultaneously;
collecting auction progress data during the plurality of auctions;
ranking the plurality of auctions based at least upon at least one of a current bid price, a number of bidders, and a percentage increase in a most recent bid; and
delisting the item from all but one of the auctions based at least upon the ranking.

24. The method of claim 23, further comprising allowing one of the auctions to close based at least upon the ranking.

25. The method of claim 23, further comprising delisting the item from the one remaining auction.

26. The method of claim 23, wherein the plurality of auctions are ranked first based upon the current bid price and second based upon the number of bidders.
